(19) United States
(12) Patent Application Publication
(10) Pub. No.: US 2015/0222100 A1
(43) Pub. Date: Aug. 6, 2015

(54) Wire Stripping Device

(71) Applicant: Shyi-Dong Yang, Taichung City (TW)

(72) Inventor: Shyi-Dong Yang, Taichung City (TW)

(21) Appl. No.: 14/174,808

(22) Filed: Feb. 6, 2014

(51) Int. Cl. H02G 1/12

(52) U.S. Cl. CPC H02G 1/1214

(57) ABSTRACT

The wire stripper is capable of stripping a number of multiple-core wires simultaneously. A positioning element is configured along a middle section on each of a first piece and a second piece. The positioning elements provide support to the wires so as to ensure perpendicular angle of cutting. A gap is reserved between the positioning elements and the first and second pieces, and is for collecting some residuals from removed wire jacket. A rotatable blocking element and an opposing depth control bulge are configured, respectively, adjacent to the bottom of the middle sections of the first and second pieces. By turning the blocking element, the depth control bulge is interfered by the blocking element at different distances, and the cutting by the notches is prevented from going too deep and damaging an insulation layer between the wire's core and jacket.

### BACKGROUND OF THE INVENTION

(a) Technical Field of the Invention

The present invention is generally related to wire strippers, and more particular to a wire stripper capable of stripping a number of multiple-core wires simultaneously.

(b) Description of the Prior Art

A conventional wire stripping usually contains two opposing pieces rived together so that the pieces can pivot on an axle. Along two opposing edges of the two pieces, a number of notches, usually of semi-circular shapes of different diameters, are configured. When the two pieces are closed toward each other, corresponding notches jointly form openings for receiving wires of different diameters and cut into the jackets of the wires. Then by rotating the wire stripper around the wires, the jackets can be removed without cutting the cores of the wires. Along the notches, the conventional wire stripper usually has inverted-L shaped positioning elements to prevent the notches from cutting too deep into the jackets of the wires. However, it is not uncommon that a user has exerted too much a pressure so that the notches still cut too deep into the insulation layers of the wires or even cut off the wires. On the other hand, sometimes, the positioning elements interfere each other too early so that the jackets are not cut off and cannot be stripped successfully.

### SUMMARY OF THE INVENTION

To obviate the shortcomings of prior art, a wire stripping device is provided herein that is capable of stripping a number of multiple-core wires simultaneously.

According to the present invention, a positioning element is configured along a middle section on each of a first piece and a second piece. The positioning elements provide support to the wires so as to ensure perpendicular angle of cutting. A gap is reserved between the positioning elements and the first and second pieces, and is for collecting some residuals from removed wire jacket.

Also according to the present invention, a rotatable blocking element and an opposing depth control bulge are configured, respectively, adjacent to the bottom of the middle sections of the first and second pieces. By turning the blocking element, the depth control bulge is interfered by the blocking element at different distances, and the cutting by the notches is prevented from going too deep and damaging an insulation layer between the wire's core and jacket.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become apparent to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective break-down diagram showing the various components of a wire stripping device according to an embodiment of the present invention.

FIG. 2 is a perspective diagram showing the wire stripping device of FIG. 1 after assembly.

FIG. 3 is a perspective diagram showing a first piece and a second piece of the wire stripping device of FIG. 1 being locked together in their close positions.

FIG. 4 is a planar diagram showing a first piece and a second piece of the wire stripping device of FIG. 1 being locked together in their close positions.

FIGS. 5 and 6 show the scenario of locking and unlocking a first piece and a second piece of the wire stripping device of FIG. 1 by plugging and unplugging a bolt.

FIG. 7 is a planar diagram showing a first piece and a second piece of the wire stripping device of FIG. 1 in their close positions.

FIG. 8 is a schematic diagram showing a wire being cut by the wire string device of FIG. 1.

FIG. 9 is a planar diagram showing the scenario of adjusting the cutting distance by a blocking element and a depth control bulge of the wire stripping device of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

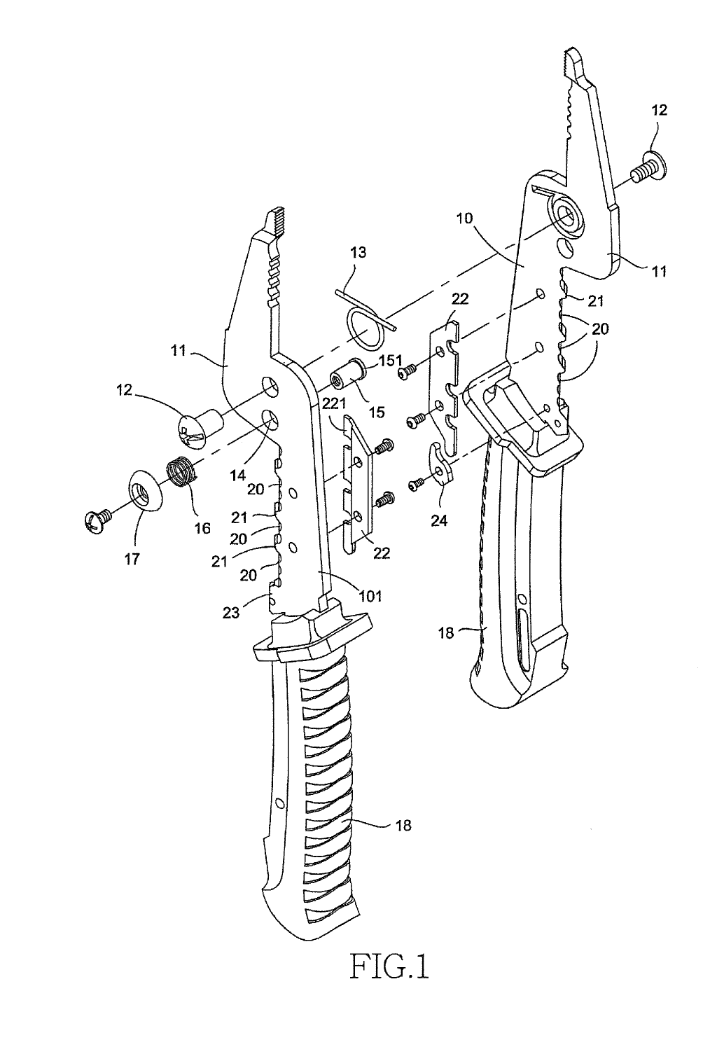

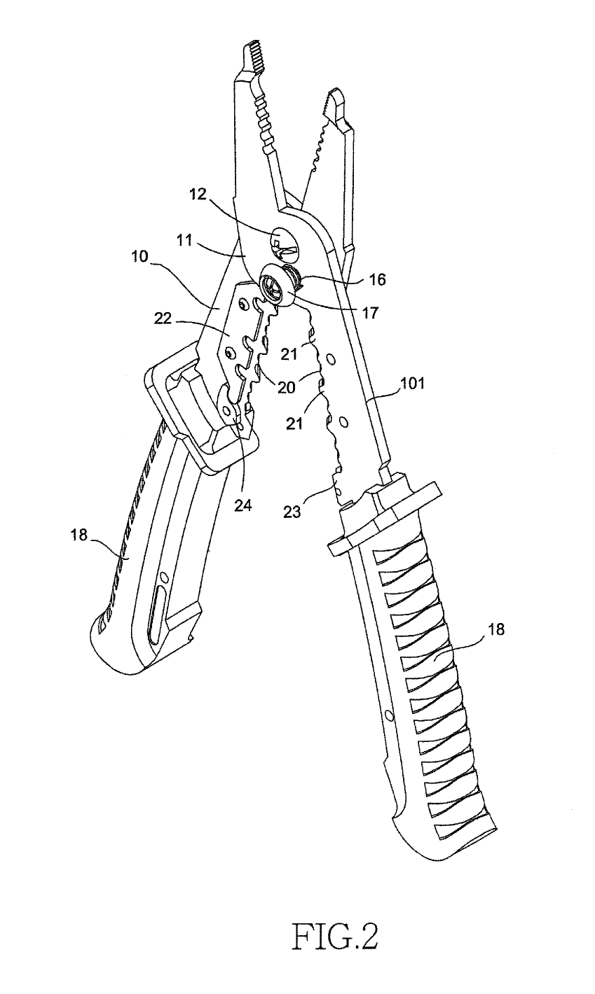

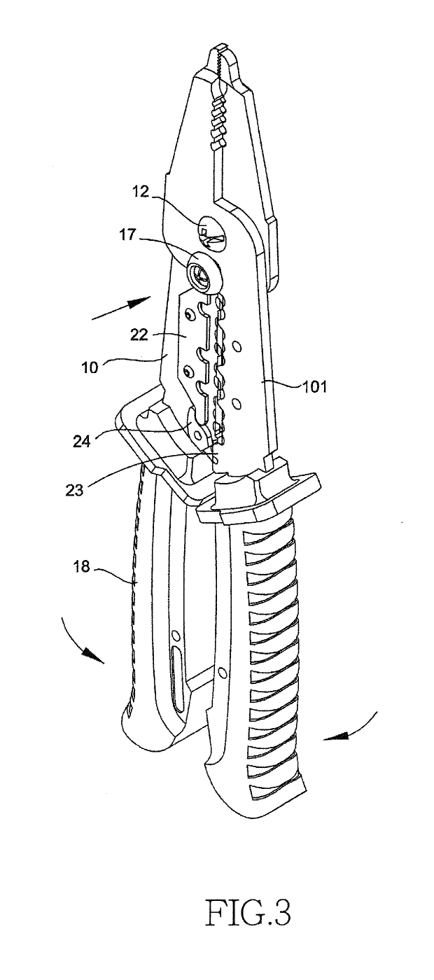

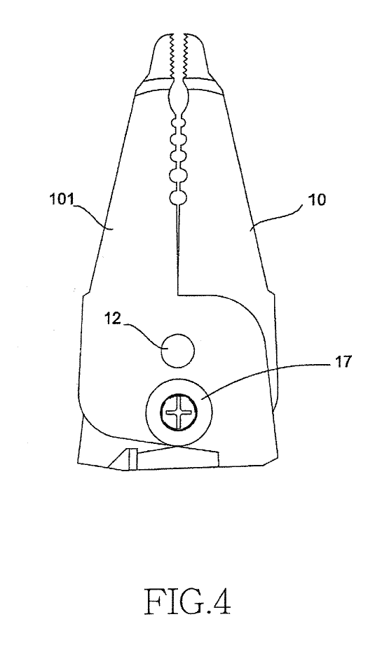

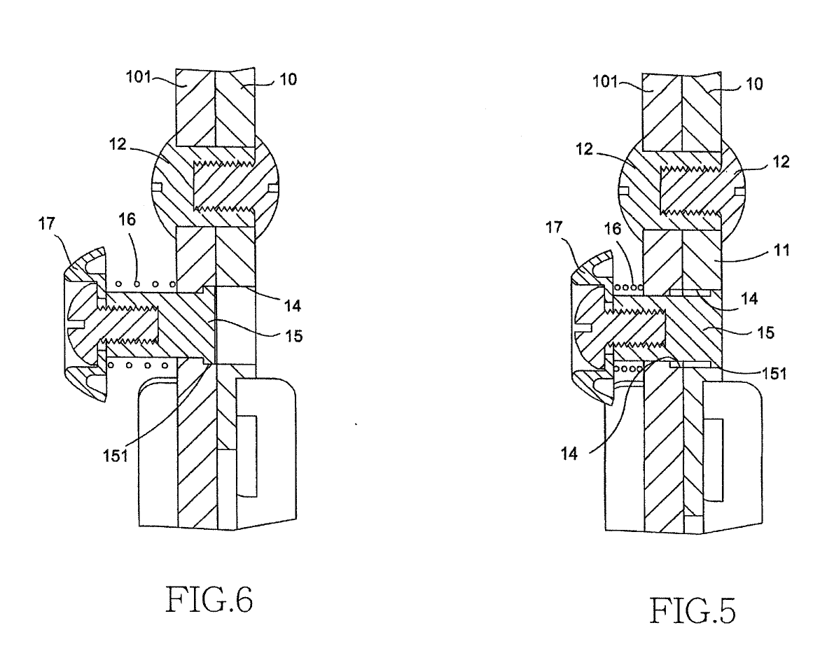

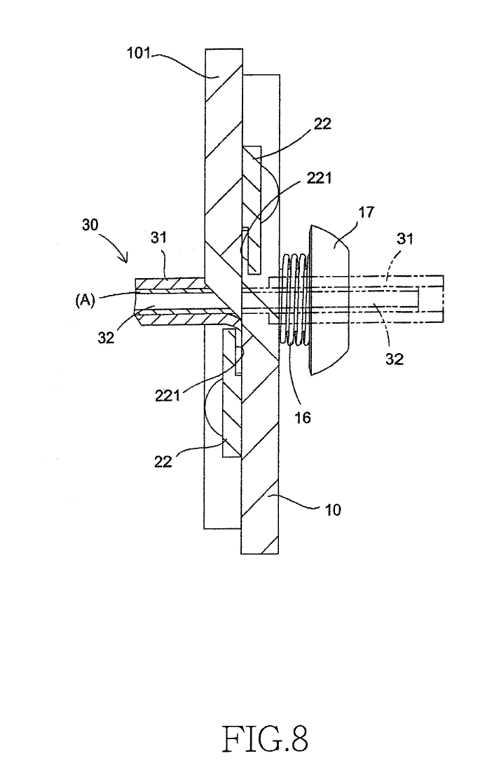

As shown in FIGS. 1 to 9, a wire stripping device according to an embodiment of the present invention contains pair of opposing pieces, a first piece 10 and a corresponding second piece 101, each having an upper section (not numbered), a joint section 11, a middle section, and a lower section from a top end to a bottom end in this order. Each lower section is wrapped in a plastic handle 18 for comfortable manipulation. A first hole (not numbered) is configured on each joint section 11. The first and second pieces 10 and 101 are riveted together by all axle 12 through the first holes on the joint sections 11 so that the first and second pieces 10 and 101 pivot on the axle 12, similar to a conventional wire stripping device. A resilient element 13 such as a torsion spring is configured between the first and second pieces 10 and 101, and is threaded through by the axle 12. The resilient element 13 is for restoring the first and second pieces 10 and 101 to their open positions after they are manually operated to strip wire jacket. Also on each joint section 11, there is a second hole 14. The hole 14 on the second piece 101 has a larger diameter slightly than that of the hole 14 on the first piece 10. A bolt 15 threads through the hole 14 on the second piece 101 from an inner side of the second piece 101 and a spring element 16 on an outer side of the second piece 101. A cap 17 also on the outer side of the second piece 101 is then joined to the bolt 15 so that the spring element 16 is sandwiched between the cap 17 and the outer side of the second piece 101. An end of the bolt 15 opposite to the cap 17 has a flange 151 with the same diameter as that of the hole 14 of the first piece 10. The bolt 15 therefore has an inverted-T shape. The opening of the hole 14 on the inner side of the second piece 101 is slightly expanded so as to receive the flange 151 of the bolt 15. As shown in FIGS. 4 to 6, when the wire stripping device is not used and has be stored, a user closes the first and second pieces 10 and 101 towards each other into their closed positions against the resilience of the resilient element 13. The bolt 15 then is pushed into the hole 14 of the first piece 10 against the resilience of the spring element 16. In the meantime, the user releases the first and second pieces 10 and 101, the resilience of the resilient element 13 tries to expand the first and second pieces 10 and 101, and their holes 14 are as such slightly misaligned. The friction exerted on the bolt 15 by the slightly misaligned holes 14 prevents the spring element 16 from restoring the bolt 15. The first and second pieces 10 and 101 are as such held in their close positions and the wire stripping device can be safely stored. To use the wire stripping device again, the user pressures the first and second pieces 10 and 101 towards each other from their closed positions, the holes 14 of the first and second pieces 10 and 101 are aligned again, the spring element 16 is allowed to expand and as such unplugs the bolt 15 out from the hole 14 of the first piece 10. The first and second pieces 10 and 101 then return to their open positions and are ready for manual wire stripping.

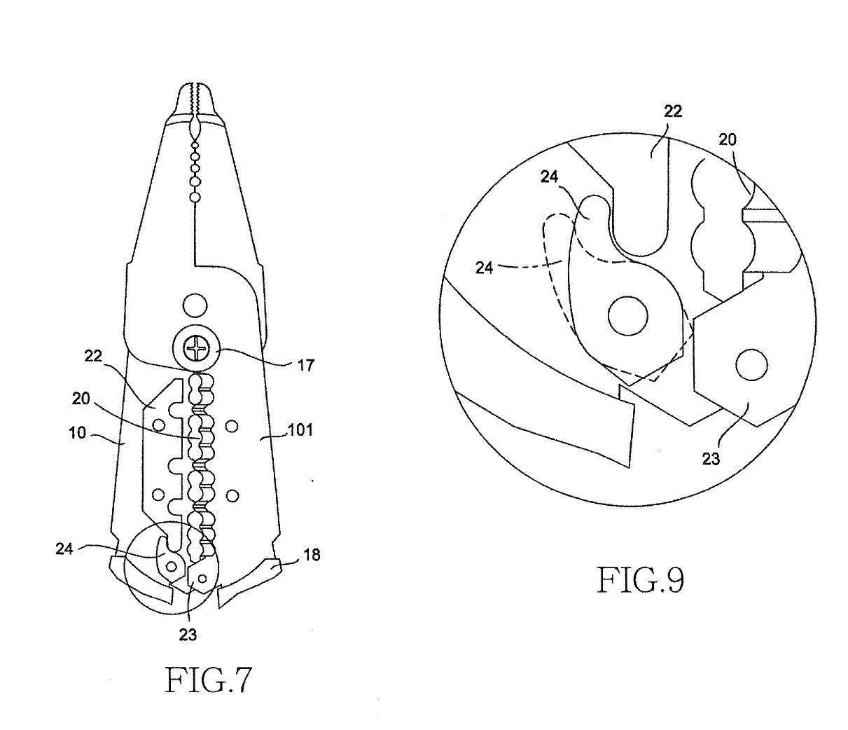

The middle sections of the first and second pieces 10 and 101 are configured with a number of notches 20 along a pair of opposing edges of the first and second pieces 10 and 101. The notches 20 are separated into a number of groups by separation bulges 21. Each group has two or three continuous notches 20. The notches 20 in a group on the first piece 10 and the corresponding notches 20 on the second piece 101 jointly form openings of varying sizes so as to fit two-core or three-core wires 30 of different diameters. The edge of each notch 20 is sharpened for easy removal of wire jacket 31. Please note that the wire stripping device thus designed allows multiple two-core or three-core wires 30 to be stripped simultaneously. Additionally, a positioning element 22 is configured along the middle section on the inner side of the first piece 10, and another positioning element 22 is configured along the middle section on the inner side of the second piece 101. The positioning elements 22 also have notches along their opposing edges and, when wires 30 are to be stripped, these positioning elements 22 provide support to the wires 30 so as to ensure the angle of cutting by the notches 20 is perpendicular to the wires 30. Please note that a gap 221 is reserved between the positioning elements 22 and the inner sides of the first and second pieces 10 and 101. The gap 221 is preferably less than 1 mm in depth. As shown in FIGS. 7 to 9, as the wire jacket 31 is stripped, some residuals from the removed wire jacket 31 can be collected by the gap 221. On the inner sides of the first piece 10 and on the outer side of the second piece 101, a rotatable blocking element 24 and an opposing depth control bulge 23 are configured, respectively, adjacent to the bottom of the middle sections of the first and second pieces 10 and 101. The circumference of the blocking element 24 contains continuous sections of different curvatures. By turning the blocking element 24 so that the depth control bulge 23 is interfered by the different sections of the blocking element 24 at different distances as the first and second pieces 10 and 101 are closed together to strip wire jacket 31, the cutting by the notches 20 is prevented from going too deep and damaging the insulation layer A between the wire 30′s core 32 and jacket 31.

The advantages of the present invention are as follows. Firstly, the configuration of the bolt 15 and the spring element 16 allow the first and second pieces 10 and 101 to be locked in their close positions for safe storage, and automatically release the first and second pieces 10 and 101 from the locked state. Additionally, the configuration of several groups of continuous notches 20 allows the stripping of multiple wires of multiple cores of different diameters simultaneously. Furthermore, the positioning elements 22 provide lateral support to the wires to be stripped. The gaps 221 between the positioning elements 22 and the first and second pieces 10 and 101 collect residual jackets 31 after they are stripped. Then, the interference between the blocking element 24 and the depth control bulge 23 prevents the notches 20 from cutting too deep into the insulation layers of the cores 32 of the wires 30. The blocking element 24 contains continuous circumferential sections of different curvatures, and as such provides fine tuning to the cutting distance of the notches 20.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A wire stripping device for stripping a wire's jacket, comprising a first piece and a corresponding second piece, each having an upper section, a joint section, a middle section, and a lower section from a top end to a bottom end of the wire stripping device in this order,
wherein
each lower section is wrapped in a plastic handle;
a first hole is configured on each joint section;
the first and second pieces are riveted together by an axle through the first holes on the joint sections so that the first and second pieces pivot on the axle;
the middle sections are configured with a plurality of notches along a pair of opposing edges of the first and second pieces;
the notches are separated into a plurality of groups by separation bulges;
there is at least one group comprising at least two continuous notches;
the notches on the first piece and the corresponding notches on the second piece jointly form openings of varying sizes so as to fit wires of different diameters;
on the inner sides of the first piece and on the outer side of the second piece, a rotatable blocking element and an opposing depth control bulge are configured, respectively, adjacent to the bottom of the middle sections of the first and second pieces; and
by turning the blocking element so that the depth control bulge is interfered by the blocking element at different distances, the cutting by the notches is prevented from going too deep and damaging an insulation layer between the wire's core and jacket.

2. The wire stripping device according to claim 1, wherein the circumference of the blocking element comprises continuous sections of different curvatures.

3. A wire stripping device for stripping a wire's jacket, comprising a first piece and a corresponding second piece, each having an upper section, a joint section, a middle section, and a lower section from a top end to a bottom end of the wire stripping device in this order,
wherein
each lower section is wrapped in a plastic handle;
a first hole is configured on each joint section;
the first and second pieces are riveted together by an axle through the first holes on the joint sections so that the first and second pieces pivot on the axle;
the middle sections are configured with a plurality of notches along a pair of opposing edges of the first and second pieces;
the notches on the first piece and the corresponding notches on the second piece jointly form openings of varying sizes so as to fit wires of different diameters;
a positioning element is configured along the middle section on an inner side of the first piece, and another positioning element is configured along the middle section on an inner side of the second piece;
the positioning elements have notches along their opposing edges so that, when at least a wire is to be stripped, the positioning elements provide support to the wires so as to ensure perpendicular angle of cutting by the notches; and
a gap is reserved between the positioning elements and the inner sides of the first and second pieces.

4. The wire stripping device according to claim 3, wherein the gap is less than 1 mm in depth.
